(19) United States
(12) Patent Application Publication
(10) Pub. No.: US 2012/0269947 A1
(43) Pub. Date: Oct. 25, 2012

(54) FLAVOR IMPROVING MATERIALS

(76) Inventors: Hiroki Osanai, Kawasaki-shi (JP); Yukiko Takakura, Kawasaki-shi (JP)

(21) Appl. No.: 13/528,083

(22) Filed: Jun. 20, 2012

Related U.S. Application Data
(63) Continuation of application No. PCT/JP2010/073488, filed on Dec. 17, 2010.

(30) Foreign Application Priority Data
Dec. 21, 2009 (JP) 2009-289510

(51) Int. Cl. A23L 1/226

(52) U.S. Cl. 426/536; 426/534

(57) ABSTRACT

A method for imparting an aroma and/or flavor to a food product is provided. An aroma and/or flavor imparting composition containing any of (i) decanoic acid, (ii) octanoic acid and (iii) any one or more of acetol, furfural, methyltetrahydrofuranone and 2-acetyl-5-methylfuran, wherein when the amount, in parts by weight, of (i) the decanoic acid is “A”, the amount of (ii) the octanoic acid is “B”, and the total amount of (iii) acetol, furfural, methyltetrahydrofuranone and 2-acetyl-5-methylfuran is “C” and when A+B+C=100, then the addition to the beverage/food product is conducted to give a formulation shown by 0≦A≦60, 0≦B≦100, 0≦C≦100, 3A+B≦180.

This application is a Continuation of, and claims priority under 35 U.S.C. §120 to, International Application No. PCT/JP2010/073488, filed Dec. 17, 2010, and claims priority therethrough under 35 U.S.C. §119 to Japanese Patent Application No. 2009-289510, filed on Dec. 21, 2009, the entireties of which are incorporated by reference herein.

### BACKGROUND OF THE INVENTION

1. Technical Field

The present invention relates to a composition and a method for imparting an aroma and/or a flavor to a food product.

2. Background Art

Meat soup stock, including a Chinese soup called “tang” as well as stocks used in a western style cuisine such as pork bouillon, chicken bouillon, and beef bouillon, often serve as the base for prepared food. However, commercially available meat extract tends to deteriorate when heated during the manufacturing process. Therefore, the development of a seasoning having an inherent meat flavor is desirable. Analyses of meat flavors can be found in the literature (Muriel et al., “Volatile compounds on the surface and within Iberian dry-cured loin”, European Food Research and Technology (2004), 219(5), 445-451; Garcia-Esteban et al., “Comparison of simultaneous distillation extraction (SDE) and solid-phase microextraction (SPME) for the analysis of volatile compounds in dry-cured ham,” Bromatologia, Journal of the Science of Food and Agriculture (2004), 84(11), 1364-1370; Dirinck et al., “SDE-GC-MS profiling of short- and long-term ripened fermented sausages,” Food Flavors and Chemistry : Advances of the New Millennium, Royal Society of Chemistry (2001); Noleau et al., “Volatile components of roasted chicken fat”, Lebensm-Wiss. u.- Technol., 20, 37-41 (1987)).

However, Muriel et al. relates to an analysis of a Iberian swine salt-preserved meat loin, including a description of 100 or more components and the peak areas thereof, as well as a discussion of a difference between the inside and the outside of the meat, such as the difference in the 2-methylpropanol content between the surface and the inside of a meat. Muriel et al. also discloses that the profile is similar to those of other processed meats or other type of dried sausages. Garcia-Esteban et al. also relates to an analysis of a salt-preserved ham and includes a description of 100 or more components and the peak areas thereof. Both Muriel et al. and Garcia-Esteban et al. fail to describe the concentrations of the respective components as well as their effect on taste and flavor.

Dirinck et al. relates to an analysis of a fermented sausage and includes a description of 100 or more flavor compounds and the concentrations thereof. Nevertheless, it is difficult in fact to reproduce these compounds precisely according to the analyzed values. It is also understood that by using only a compound present at a high concentration the flavor cannot be reproduced. Noleau et al. includes the description of 100 or more flavor compounds and the concentrations thereof. Nevertheless, it is difficult in fact to reproduce these compounds precisely according to the analyzed values. It is also understood that by using only a compound present at a high concentration the flavor cannot be reproduced. Noleau et al. relates to a flavor composition extracted from the oil drippings of roasted chicken meat, and this flavor is assigned specifically to the fat aroma of the roasted chicken and did not include any description or suggestion of a flavor exhibiting a mellowness or a body inherent to the meat. In addition, even if a part of the reported compounds are incorporated in accordance with the analyzed values, it was not possible, due to a negligible effect or an excessively imparted aroma, to provide a favorable aroma and/or flavor which embodies the qualities of a meat soup stock. Under the circumstances described above, a food material capable of being used more widely and having a high aroma and flavor improving effect is clearly desirable.

### SUMMARY OF THE INVENTION

It is an aspect of the present invention to provide a method for producing a beverage/food product having an improved aroma and/or flavor comprising adding (i) decanoic acid, (ii) octanoic acid and (iii) a component selected from the group consisting of acetol, furfural, methyltetrahydrofuranone, 2-acetyl-5-methylfuran, and combinations thereof; wherein when the amount of the decanoic acid is A, the amount of the octanoic acid is B and the total amount of (iii) acetol, furfural, methyltetrahydrofuranone, and/or 2-acetyl-5-methylfuran is C; and when A+B+C=100, then said adding is conducted to result in a formulation selected from the group consisting of:
(a) 0<A≦60, 0<B<100, 0<C<100, 3A+B≦180
(b) 0<A≦60, 0<B≦90, 0<C<100, 3A+B≦180
(c) 0<A≦50, 0<B≦50, 50≦C<100
(d) 0<A≦40, 60≦B<100, 0<C≦40, and
(e) 0<A≦40, 60≦B≦90, 0<C≦40.

It is further aspect of the present invention to provide the method as described above, comprising a further step of adding a component selected from the group consisting of tetradecanoic acid, hexadecanoic acid, octadecanoic acid, oleic acid, and combinations thereof.

It is further aspect of the present invention to provide the method as described above, wherein the total amount of said (i), (ii), and (iii) is at least 10 ppb and less than or equal to 1000 ppm.

It is further aspect of the present invention to provide a composition comprising (i) decanoic acid, (ii) octanoic acid and (iii) a further component selected from the group consisting of acetol, furfural, methyltetrahydrofuranone and 2-acetyl-5-methylfuran, wherein when the amount of the decanoic acid is A, the amount of the octanoic acid is B and the total amount of (iii) acetol, furfural, methyltetrahydrofuranone, and/or 2-acetyl-5-methylfuran is C; and when A+B+C=100, then said comprises a formulation selected from the group consisting of:
(a) 0<A≦60, 0<B<100, 0<C<100, 3A+B≦180
(b) 0<A≦60, 0<B≦90, 0<C<100, 3A+B≦180
(c) 0<A≦50, 0<B≦50, 50≦C<100
(d) 0<A≦40, 60≦B<100, 0<C≦40, and
(e) 0<A≦40, 60≦B≦90, 0<C≦40.

It is further aspect of the present invention to provide the composition as described above , further comprising a component selected the group consisting of tetradecanoic acid, hexadecanoic acid, octadecanoic acid, oleic acid, and combinations thereof.

It is further aspect of the present invention to provide a food product comprising the composition as described above, wherein the amount of the decanoic acid is A, the amount of the octanoic acid is B, and the total amount of acetol, furfural, methyltetrahydrofuranone and/or 2-acetyl-5-methylfuran is C, and wherein when A+B+C=100, then said composition comprises said component according to a formulation selected from the group consisting of:
(a) 0<A≦60, 0<B<100, 0<C<100, 3A+B≦180; (b) 0<A≦60, 0<B≦90, 0<C<100, 3A+B≦180; (c) 0<A≦50, 0<B≦50, 50≦C<100; (d) 0<A≦40, 60≦B<100, 0<C≦40, and (e) 0<A≦40, 60≦B≦90, 0<C≦40;
   wherein the total amount of (i), (ii), and (iii) is at least 10 ppb and less than or equal to 1000 ppm.

It is further aspect of the present invention to provide a method for improving an aroma and/or a flavor of a food product comprising adding the composition as described above to a food product in need of improved aroma and/or flavor, wherein the total amount of (i), (ii), and (iii) is at least 10 ppb and less than or equal to 1000 ppm.

It is further aspect of the present invention to provide a method for producing a food product having an improved aroma and/or flavor comprising adding the composition as described above to a food product in need of improved aroma and/or flavor, wherein the total amount of (i), (ii), and (iii) is 10 ppb or more and 1000 ppm or less.

The present invention also encompasses a combination of any of these respective aspects as well as the representation of the invention involving any replacement between the methods, the devices and the like.

A method for imparting an aroma and/or a flavor, especially a meat soup stock-like aroma and/or flavor to a food product is provided.

### BRIEF DESCRIPTION OF THE DRAWINGS

FIG. 1 is a ternary plot indicating the results of the organoleptic evaluation in a soup system attributable to the difference in the ratio of each formulated product of an aroma and/or flavor imparting composition containing any of decanoic acid, octanoic acid and acetol.

FIG. 2 is a simplified view of a ternary plot indicating the results of the organoleptic evaluation in a soup system attributable to the difference in the ratio of each formulated product of an aroma and/or flavor imparting composition containing any of decanoic acid, octanoic acid and acetol.

### DESCRIPTION OF THE PREFERRED EMBODIMENTS

A meat soup stock can be prepared by an ordinary method, and then the important aroma components can be identified. Specifically, a vacuum distillant of a diethyl ether extract of a meat stock soup was prepared and subjected to gas chromatography. The sniffing method can be used to identify the components.

As a result of these studies, it was found that the responsible components of a meat soup stock include, contrary to those analytics shown in the literature, (i) decanoic acid, (ii) octanoic acid and (iii) acetol, among the many possible components. Nevertheless, when the these three compoments were quantified by gas chromatography - mass spectrometry (GC-MS), and the quantification results were employed in an attempt to reproduce a meat soup stock such as a chicken or a pork soup stock in the form of an aqueous solution or a meat soup or extract, the aroma was far different from the original meat soup stock.

Accordingly, as a result of a further intensive study, it was discovered that this problem can be solved by changing the ratio of the amounts of (i) the decanoic acid, (ii) the octanoic acid and (iii) the acetol rather than reproducing the contents of (i) the decanoic acid, (ii) the octanoic acid and (iii) the acetol in the meat soup stock.

It was further discovered, as a result of an intensive study on a compound having an aroma and/or a flavor similar to that of the acetol, that several furan ring-carrying compounds have effects similar to that of the acetol. A furan ring compound can include furfural, methyltetrahydrofuranone, and/or 2-acetyl-5-methylfuran.

The term “aroma” can mean a scent sensed only by a nose without eating or drinking, that is, orthonasal flavor. The term “flavor” can mean a scent entering the nose from an oral cavity upon eating or drinking, that is, retronasal flavor.

The addition of a composition to a beverage/food product in need of improved aroma and/or flavor can be made in such a manner that any of (i) decanoic acid, (ii) octanoic acid and (iii) any one or more of acetol, furfural, methyltetrahydrofuranone and 2-acetyl-5-methylfuran can be added, and the ratios, in parts by weight, of (i) decanoic acid—indicated as “A”, (ii) octanoic acid—indicated as “B” and (iii) the total of acetol, furfural, methyltetrahydrofuranone and 2-acetyl-5-methylfuran—indicated as “C”, can be 0≦A≦60, 0≦B≦100, 0≦C≦100, 3A+B≦180, wherein A+B+C=100. A departure from this concentration range can result in an undesirable irritating odor. Formulation ratios within the range of 0≦A≦60, 0≦B≦90, 0≦C≦100; 0≦A≦50, 0≦B≦50, 50≦C≦100; and 0≦A≦40, 0≦B≦40, 60≦C≦100 can result in more intense potency and improved meat-like long-lastingness and body. Furthermore, formulation ratios of 0≦A≦40, 60≦B≦100, 0≦C≦40; 0≦A≦40, 60≦B≦90, 0≦C≦40; 0≦A≦30, 70≦B≦100, 0≦C≦30; and 0≦A≦30, 70≦B≦90, 0≦C≦30 can result in a more intense potency and improved meat-like mellowness and body. By adding the aforementioned components to a food/beverage product in any of the aforementioned incorporation ratios, an improvement in the aroma and/or flavor quality, especially a meat soup stock-like aroma and/or flavor quality of the entire food/beverage product can be realized.

An aroma and/or flavor imparting composition can be characterized by the presence of any of the following substances: (i) decanoic acid, (ii) octanoic acid and (iii) any one or more of acetol, furfural, methyltetrahydrofuranone and 2-acetyl-5-methylfuran. The ratios in parts by weight of (i) decanoic acid, represented by “A”, (ii) octanoic acid, represented by “B” and (iii) a total of acetol, furfural, methyltetrahydrofuranone and 2-acetyl-5-methylfuran, represented by “C”, can be 0≦A≦60, 0≦B≦100, 0≦C≦100, 3A+B≦180, wherein A+B+C=100. A departure from this concentration range can result in an undesirable irritating odor. A ratio within the range of 0≦A≦60, 0≦B≦90, 0≦C≦100; 0≦A≦50, 0≦B≦50, 50≦C≦100; 0≦A≦40, 0≦B≦40, 60≦C≦100 can result in a more intense potency and improved meat-like long-lastingness and body. Furthermore, a ratio of 0≦A≦40, 60≦B≦100, 0≦C≦40; 0≦A≦40, 60≦B≦90, 0≦C≦40; 0≦A≦30, 70≦B≦100, 0≦C≦30; 0≦A≦30, 70≦B≦90, 0≦C≦30 can result in a more intense potency and improved meat-like mellowness and body. By adding the aroma and/or flavor imparting composition to a food/beverage product, an improvement in the aroma and/or flavor, especially a meat soup stock-like aroma and /or flavor, of the entire food/beverage product can be realized.

Generally one, two, or even three components, such as (i) decanoic acid, (ii) octanoic acid and (iii) any one or more of acetol, furfural, methyltetrahydrofuranone and 2-acetyl-5-methylfuran, can be present in the composition and result in an excellent organoleptic quality. In the Examples, every range of a certain value gives a better result when the range does not include the endpoint values of the range, such as those expressed by “more than” and “less than” (i.e.“<”), than when the range includes the endpoint values of the range, such as those expressed by “or more” and “or less” (i.e.“≦”). Accordingly, the ranges include their endpoints in their endpoint regions, but those excluding the endpoints are also included.

Among the components making up (iii), that is, acetol, furfural, methyltetrahydrofuranone and 2-acetyl-5-methylfuran, any of these components may be used, and when calculating the ratios of (i), (ii) and (iii), the total of the components of (iii) should be calculated.

The three components can be present, for example, in pork meat, in a ratio of 60<A<100, 0<B<40, 0<C<40, 3A+B>180, wherein the amount, in parts by weight, of (i) is “A” , the amount of (ii) is “B”, and the total amount of (iii) is “C” and wherein A+B+C=100.

Decanoic acid is a straight-chained fatty acid having 10 carbon atoms, and is also known by its common name, capric acid. Octanoic acid is a straight-chained fatty acid having 8 carbon atoms and is also known by its common name, caprylic acid. Acetol is a compound having one ketone group and one hydroxy group, and is also known by its common names, hydroxyacetone, 1-hydroxy-2-propanone, pyrvic alcohol and 1-hydroxypropan-2-one.

Furfural is a compound having one aldehyde group on a furan ring and is called 2-furancarboxyaldehyde under the IUPAC nomenclature system. Methyltetrahydrofuranone is a compound having one methyl group and carbonyl group on a furan ring, and is called 2-methyltetrahydrofuran-3-one under the IUPAC nomenclature system. 2-acetyl-5-methylfuran is a compound having one acetyl group and one methyl group on a furan ring.

Adding any one or more of tetradecanoic acid, hexadecanoic acid, octadecanoic acid and oleic acid to a mixture of one or more of (i) decanoic acid, (ii) octanoic acid and (iii) any one or more of acetol, furfural, methyltetrahydrofuranone and 2-acetyl-5-methylfuran, a meat-like long-lastingness and body can be further improved.

Tetradecanoic acid is a straight-chained fatty acid having 14 carbon atoms and is also known by its common name myristic acid. Hexadecanoic acid is a straight-chained fatty acid having 16 carbon atoms and is also known by its a common name palmitic acid. Octadecanoic acid is a straight-chained fatty acid having 18 carbon atoms and is also known by its common name stearic acid.

Oleic acid is a monovalent unsaturated fatty acid having a C18 chain.

The tetradecanoic acid, hexadecanoic acid, octadecanoic acid or oleic acid content in the final food product can be 0.01 to 1000 ppm, or 0.1 to 100 ppm. The lower the amount, the more difficult to realize the effect. While a higher content can be acceptable, such a higher content does not allow a marked effect to be observed.

One or more of (i) decanoic acid, (ii) octanoic acid and (iii) any one or more of acetol, furfural, methyltetrahydrofuranone and 2-acetyl-5-methylfuran can be present in a food/beverage product at 10 ppb or more and 1000 ppm or less. To achieve more potent meat soup stock-like aroma and/or flavor, a level of 100 ppb or more and 100 ppm, or 100 ppb or more and 10 ppb or less or less can be used. A level of 10 ppb or less gives a poor effect of the addition, while a level of 1000 ppm or more is not desirable because of a strong irritating odor.

The starting material for an aroma and/or flavor imparting composition can be synthetic materials, extracts, fermented materials, heat reaction products of various materials and the like, as long as it can be employed in a food/beverage product. Upon using such a starting material for the aroma and/or flavor imparting composition, the manner of the use is not limited particularly and may include directly adding the starting material to the aroma and/or flavor imparting composition, adding after dilution with water or a solvent, or admixing in the form of a yeast extract, meat extract, seafood extract or protein hydrolysate to the aroma and/or flavor imparting composition.

When using in a food product, an aroma and/or flavor imparting composition that has already been formulated may be added, or the components (i), (ii) and (iii) may be individually added directly to the food product. When adding the flavor imparting composition or the components (i), (ii) and (iii) to the food product, they may be in a form including but not limited to a dry powder, paste, solution and the like. As for when during and after production they may be added, they may be added to the food product or seasoning before the production of the food product or the seasoning when it is still a starting material, during the production, after the production, immediately before eating, during eating, and the like.

While the food/beverage product to which the aroma and/or flavor is imparted is not limited particularly, a marked effect can be observed in a food/beverage product containing a processed meat product or a meat extract, especially a processed pork product or a pork extract. Particular examples include western style cuisine such as consommé soup, curry, beef stew, white stew, steak, hamburger steak, cutlet and the like; Chinese style cuisine such as a Chinese soup, fried dumpling, steamed dumpling, fried rice, deep fried chicken and the like; Japanese style cuisine such as simmered potatoes with sliced beef called “Nikujaga” and simmered root crops with chopped chicken called “Chikuzen-ni”, various seasonings such as Worcestershire sauce, demi-glace sauce, ketchup, various dip sauces, a flavor seasoning such as a chicken soup stock, pork soup stock and the like, a cooked rice meal such as a rice ball called “Onigiri” and pilaf.

The present invention is further described in the following non-limiting Examples.

### EXAMPLES

### Example 1

### Effect of Different Ratios of Aroma and/or Flavor Imparting Composition in a Soup System on Organoleptic Evaluation

<Preparation of Pork Meat Soup Stock>

Ham meat was pre-treated by boiling for 5 minutes while removing the scum. 1.6 kg of the pre-treated ham meat and 10.1 kg of water were placed into a cylindrical container and cooked over a high flame until boiling, and thereafter simmered gently for 4 hours. The scum generated during heating and simmering was removed as needed. After simmering for 4 hours, the broth was filtered through a paper filter to obtain a pork soup stock.

<Addition of Aroma and/or Flavor Imparting Component to Pork Meat Soup Stock in Various Incorporation Ratios>

To the pork meat soup stock prepared in Example 1, three components, namely, decanoic acid, octanoic acid and acetol were added in respective ratios varying at 10% intervals so that the total concentration of the three components became 61.05 ppm. A pork meat soup stock containing none of the three components was used as a control.

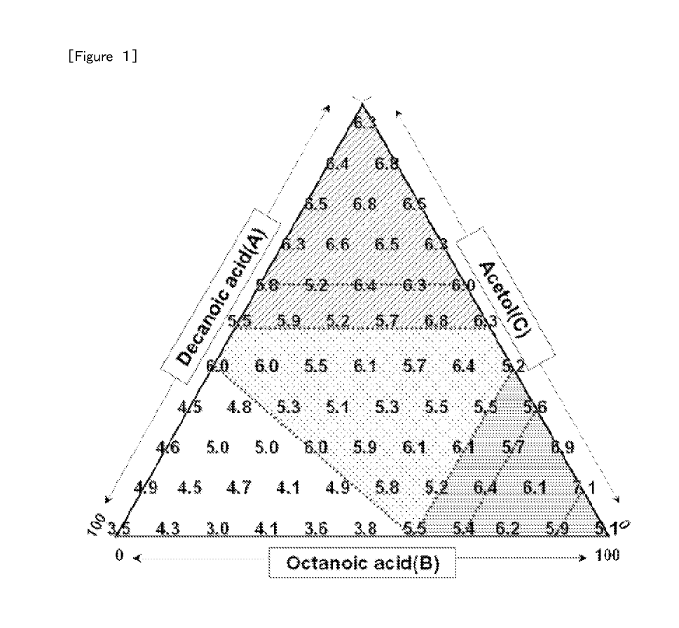

The organoleptic evaluation was made by a thoroughly trained 5 special panelists to evaluate the aroma and/or flavor of the meat soup stock, while assigning 5 points to the control and 10 points to the maximum and allowing for free comment. The results are shown in FIG. 1.

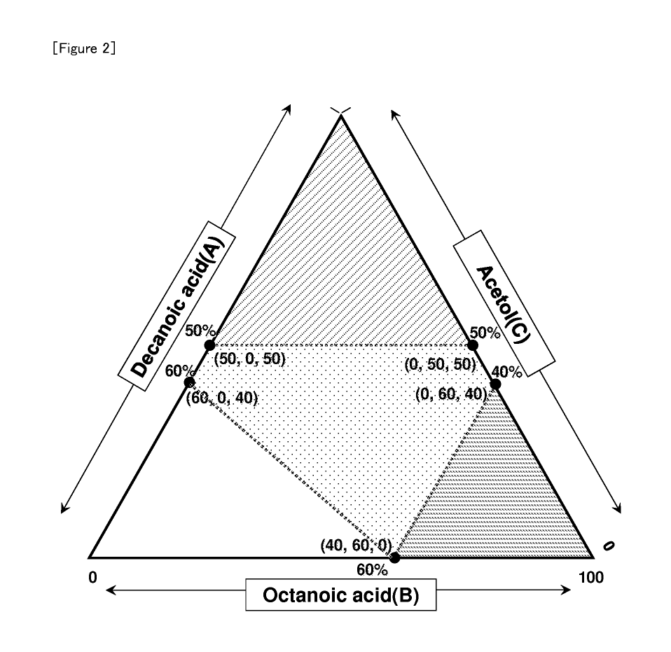

As evident from FIG. 1 and FIG. 2 which summarizes FIG. 1, it was revealed that, when the amount, all in parts by weight, of the decanoic acid is “A”, the amount of the octanoic acid is “B” and the amount of acetol is “C” , and when A+B+C=100, a desirable meat soup stock aroma and/or flavor was imparted according to ratios represented by 0≦A≦60, 0≦B≦100, 0≦C≦100, 3A+B≦180 on a ternary plot shown in FIG. 1 or FIG. 2 (dotted zone +hatched zone +laterally striped zone in FIG. 1 or FIG. 2). Also, on the ternary plot shown in FIG. 1 or FIG. 2, the region surrounded by 0≦A≦50, 0≦B≦50, 50≦C≦100 (hatched zone in FIG. 1 or FIG. 2) was revealed to represent a desirable meat soup stock aroma and/or flavor which is more intense, and meat-like long-lastingness and body is imparted. Moreover, the region surrounded by 0≦A≦40, 0≦B≦40, 60≦C≦100 was revealed to represent a desirable meat soup stock aroma and/or flavor which is more intense and a meat-like long-lastingness and body is more markedly imparted. Furthermore, the region surrounded by 0≦A≦40, 60≦B≦100, 0≦C≦40 (laterally stripped zone in FIG. 1 or FIG. 2) was revealed to represent a desirable meat soup stock aroma and/or flavor which is more intense and a meat-like mellowness and body is imparted. Moreover, a region surrounded by 0≦A≦40, 60≦B≦90, 0≦C≦40 was revealed to represent a preferable meat soup stock aroma and/or flavor which is more intense and a meat-like mellowness and body is more markedly imparted. Moreover, a region surrounded by 0≦A≦30, 70≦B≦100, 0≦C≦30 was revealed to represent a desirable meat soup stock aroma and/or flavor which is more intense and a meat-like mellowness and body is more markedly imparted. Moreover, a region surrounded by 0≦A≦30, 70≦B≦90, 0≦C≦30 was revealed to represent a desirable meat soup stock aroma and/or flavor which is more intense and a meat-like mellowness and body is more markedly imparted.

It was revealed that generally one, two, or even three components from among decanoic acid, octanoic acid and acetol or equivalent can be used for an excellent organoleptic qualities. In the results, every range of a certain value gives a better result when the range does not include the endpoint values of that range, such as those expressed by “more than” and “less than” (i.e.“<”), than when the range includes the endpoint values of the range, such as those expressed by “or more” and “or less” (i.e.“≦”). Accordingly, the ranges include their endpoints in their endpoint regions, but those excluding the endpoints are also included.

### Example 2

### Effect of Different Concentrations in a Soup System of Aroma and/or Flavor Imparting Composition on Organoleptic Evaluation

<Addition of Aroma and/or Flavor Imparting Composition to Pork Meat Soup Stock at Various Concentration>

To the pork meat soup stock prepared as described above, decanoic acid, octanoic acid and acetol in ratios of 10%, 10%, 80% (Formulation 1), respectively, or decanoic acid, octanoic acid and acetol in ratios of 62.6%, 34.7%, 2.7% (Formulation 2), respectively, were added such that the total concentration of the three components became 1 ppb, 10 ppb, 100 ppb, 10 ppm, 1000 ppm and 1%. A pork meat soup stock containing none of the three components was used as a control.

The organoleptic evaluation was made by a thoroughly trained 3 special panelists to evaluate the aroma and/or flavor of the meat soup stock, while assigning 5 points to the control and 10 points to the maximum and allowing for free comments. The results are shown in Table 1.

TABLE 1
Organoleptic evaluation of soup systems having different
concentrations of aroma and/or flavor imparting composition

| 3 component | Score | Score |
|---|---|---|
| concentration | (formulation 1) | (formulation 2) |
| 1 ppb | 5.0 | 3.8 |
| 10 ppb | 5.8 | 3.9 |
| 100 ppm | 6.5 | 3.2 |
| 10 ppm | 6.8 | 2.8 |
| 1000 ppm | 5.8 | 0.3 |
| 1% | 3.0 | 0.3 |
| Control | 5.0 | 5.0 |

Based on the results shown in Table 1, decanoic acid, octanoic acid, acetol incorporated in ratios of 10%, 10%, 80% (Formulation 1), respectively, exhibited a score equal or superior to that of the control when a total concentration of three components was 1 ppb to less than 1%, and a more desirable meat soup stock aroma and/or flavor was obtained at 10 ppb to 1000 ppm. It was also revealed that a concentration of 100 ppb to 10 ppm was further desirable. A concentration less than 1 ppb exhibited no apparent effect of the addition, while a concentration of 1% or more exhibited a peculiar flavor such as an irritating odor because the addition was excessive. When decanoic acid, octanoic acid, and acetol incorporated in ratios of 62.6%, 34.7% and 2.7% (Formulation 2), respectively, no desirable meat soup stock aroma and/or flavor was obtained at any total concentration of the three components within the range of 1 ppb to 1%. A concentration of 100 ppb or more exhibited a peculiar flavor such as the smell of a soap because the addition was excessive.

### Example 3

### Evaluation of Furan Ring Compound Incorporation

<Preparation of Meat-Based Flavor Seasoning>

Starting materials for a food were mixed in an incorporation ratio indicated in Table 2 shown below to produce a powdery meat-based flavor seasoning. These starting materials for a food were all commercially available products.

TABLE 2

| | Incorporation ratio |
|---|---|
| Salt | 40 |
| Sodium glutamate | 35 |
| Sugar | 20 |
| Meat extract | 4 |
| Inosinic acid | 1 |

<Addition of Furan Ring Compound-Containing Flavor Composition to Meat-Based Flavor Seasoning>

1.3 g of the meat-based flavor seasoning shown in Table 2 was dissolved in 98.7 g of warm water to produce a 1.3% meat-based flavor seasoning. To this, (i) decanoic acid, (ii) octanoic acid and (iii) any one of acetol, furfural, methyltetrahydrofuranone and 2-acetyl-5-methylfuran, in ratios of (i) 8%, (ii) 8%, (iii) 84% (Formulation 1), respectively, or in ratios of (i) 31%, (ii) 49%, (iii) 20% (Formulation 2), respectively, or in ratios of (i) 80%, (ii) 10%, (iii) 10% (Formulation 3), respectively, were added such that the total concentration of the three components (i), (ii) and (iii) became 61.05 ppm. A meat-based flavor seasoning containing none of the three components was used as a control.

The organoleptic evaluation was made by a thoroughly trained 2 special panelists to evaluate the aroma and/or flavor of the meat soup stock, while assigning 5 points to the control and 10 points to the maximum and allowing for free comments. The results are shown in Table 3.

TABLE 3
Organoleptic evaluation of flavor compositions having
difference in (iii) acetol, furfural, methyltetrahydrofuranone
and 2-acetyl-5-methylfuran

| Component (iii) | Formulation 1 | Formulation 2 | Formulation 3 |
|---|---|---|---|
| Acetol | 7.0 | 5.8 | 2.5 |
| Furfural | 6.5 | 5.5 | 2.5 |
| Methyltetrahydro- | 6.5 | 5.5 | 2.0 |
| furanone | | | |
| 2-acetyl-5-methylfuran | 5.8 | 5.3 | 2.0 |

Based on the results shown in Table 3, (i) decanoic acid, (ii) octanoic acid and (iii) any one or more of acetol, furfural, methyltetrahydrofuranone and 2-acetyl-5-methylfuran incorporated in ratios of (i) 8%, (ii) 8%, (iii) 84% (Formulation 1), respectively, imparted an especially desirable meat soup stock aroma and/or flavor, with the components other than acetol exhibiting scores not less than that of the control similarly to acetol. (i) Decanoic acid, (ii) octanoic acid and (iii) any one or more of acetol, furfural, methyltetrahydrofuranone and 2-acetyl-5-methylfuran incorporated in ratios of (i) 31%, (ii) 49%, (iii) 20% (Formulation 2), respectively, also imparted a desirable meat soup stock aroma and/or flavor, with the components other than acetol exhibiting scores not less than that of the control similarly to acetol. (i) Decanoic acid, (ii) octanoic acid and (iii) any one or more of acetol, furfural, methyltetrahydrofuranone and 2-acetyl-5-methylfuran incorporated in ratios of (i) 80%, (ii) 10%, (iii) 10% (Formulation 3), respectively, exhibited a peculiar flavor such as an irritating odor and failed to impart a desirable meat soup stock aroma and/or flavor, with the components other than acetol exhibiting scores less than that of the control similarly to acetol.

### Example 4

### Evaluation of Addition of Tetradecanoic Acid, Hexadecanoic Acid, Octadecanoic Acid and Oleic Acid

<Addition of Flavor Compositions Containing Tetradecanoic Acid, Hexadecanoic Acid, Octadecanoic Acid and Oleic Acid to Meat-Based Flavor Seasoning>

Similarly to Example 3, 1.3 g of the meat-based flavor seasoning shown in Table 2 was dissolved in 98.7 g of warm water to produce a 1.3% meat-based flavor seasoning. To this, (i) decanoic acid, (ii) octanoic acid, (iii) acetol in ratios of (i) 11%, (ii) 2%, (iii) 87%, respectively, were added so that the total concentration became 13.8 ppm to obtain a base seasoning solution. To the base seasoning solution, any of tetradecanoic acid (final concentration: 10.1 ppm), hexadecanoic acid (final concentration: 5.95 ppm), octadecanoic acid (final concentration: 0.90 ppm) or oleic acid (final concentration: 2.30 ppm) was added. A meat-based-flavor seasoning containing none of the three components (i), (ii) and (iii) was used a control.

The organoleptic evaluation was made by a thoroughly trained 4 special panelists to evaluate the desirability of the aroma and/or flavor of the meat soup stock, while assigning 5 points to the control and 10 points to the maximum and allowing a free comment to be presented. The results are shown in Table 4.

TABLE 4
Organoleptic evaluation of flavor compositions containing
tetradecanoic acid or hexadecanoic acid, octadecanoic
acid, oleic acid

| Formulation | Score |
|---|---|
| Control | 5.0 |
| (Meat-based flavor seasoning solution) | |
| Base seasoning solution | 7.0 |
| (Control + (i) decanoic acid + (ii) octanoic acid + (iii) acetol) | |
| Base seasoning solution + tetradecanoic acid | 8.6 |
| Base seasoning solution + hexadecanoic acid | 8.4 |
| Base seasoning solution + octadecanoic acid | 8.3 |
| Base seasoning solution + oleic acid | 8.1 |

Based on the results shown in Table 4, when the base seasoning solution(=meat-based flavor seasoning solution containing (i) decanoic acid, (ii) octanoic acid, (iii) acetol) was supplemented with tetradecanoic acid, hexadecanoic acid, octadecanoic acid or oleic acid at a given concentration, a score not less than those of the control and the base seasoning solution was exhibited, and a further desirable meat soup stock aroma and/or flavor was imparted.

### INDUSTRIAL APPLICABILITY

The present invention relates to a method for imparting an aroma and/or flavor to a food/beverage product.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A method for producing a beverage/food product having an improved aroma and/or flavor comprising adding to a beverage/food product in need of an improved aroma and/or flavor (i) decanoic acid, (ii) octanoic acid and (iii) a component selected from the group consisting of acetol, furfural, methyltetrahydrofuranone, 2-acetyl-5-methylfuran, and combinations thereof;
wherein the amount of the decanoic acid is A, the amount of the octanoic acid is B, and the total amount of acetol, furfural, methyltetrahydrofuranone and/or 2-acetyl-5-methylfuran is C, and
wherein when A+B+C=100, said adding is conducted to result in a formulation selected from the group consisting of:
(a) 0<A≦60, 0<B<100, 0<C<100, 3A+B≦180
(b) 0<A≦60, 0<B≦90, 0<C<100, 3A+B≦180
(c) 0<A≦50, 0<B≦50, 50≦C<100
(d) 0<A≦40, 60≦B<100, 0<C≦40, and
(e) 0<A≦40, 60≦B≦90, 0<C≦40.

2. The method according to claim 1, comprising a further step of adding a component selected from the group consisting of tetradecanoic acid, hexadecanoic acid, octadecanoic acid, oleic acid, and combinations thereof.

3. The method according to claim 1, wherein the total amount of said (i), (ii), and (iii) is at least 10 ppb and less than or equal to 1000 ppm.

4. A composition comprising (i) decanoic acid, (ii) octanoic acid and (iii) a component selected from the group consisting of: acetol, furfural, methyltetrahydrofuranone, 2-acetyl-5-methylfuran, and combinations thereof,
wherein the amount of the decanoic acid in the composition is A, the amount of the octanoic acid in the composition is B, and the total amount of acetol, furfural, methyltetrahydrofuranone and/or 2-acetyl-5-methylfuran in the composition is C, and
wherein when A+B+C=100, said composition comprises a formulation selected from the group consisting of:
(a) 0<A≦60, 0<B<100, 0<C<100, 3A+B≦180
(b) 0<A≦60, 0<B≦90, 0<C<100, 3A+B≦180
(c) 0<A≦50, 0<B≦50, 50≦C<100
(d) 0<A≦40, 60≦B<100, 0<C≦40, and
(e) 0<A≦40, 60≦B≦90, 0<C≦40.

5. The composition according to claim 4, further comprising a component selected from the group consisting of tetradecanoic acid, hexadecanoic acid, octadecanoic acid, oleic acid, and combinations thereof.

6. A food product comprising the composition according to claim 4, wherein the amount of the decanoic acid is A, the amount of the octanoic acid is B, and the total amount of acetol, furfural, methyltetrahydrofuranone and/or 2-acetyl-5-methylfuran is C, and
wherein when A+B+C=100, then said composition comprises said component(s) according to a formulation selected from the group consisting of:
(a) 0<A≦60, 0<B<100, 0<C<100, 3A+B≦180
(b) 0<A≦60, 0<B≦90, 0<C<100, 3A+B≦180
(c) 0<A≦50, 0<B≦50, 50≦C<100
(d) 0<A≦40, 60≦B<100, 0<C≦40, and
(e) 0<A≦40, 60≦B≦90, 0<C≦40.
wherein the total amount in said food product of (i), (ii), and (iii) is at least 10 ppb and less than or equal to 1000 pp.

7. A method for improving an aroma and/or a flavor of a food product comprising adding the composition according to claim 4 to a food product in need of improved aroma and/or flavor, wherein the total amount of (i), (ii), and (iii) in the food product is at least 10 ppb and less than or equal to 1000 ppm.

8. A method for producing a food product having an improved aroma and/or flavor comprising adding the composition according to claim 4 to a food product in need of improved aroma and/or flavor, wherein the total amount of (i), (ii), and (iii) in the food product is at least 10 ppb and less than or equal to 1000 ppm.
